(19) United States
(12) Patent Application Publication
(10) Pub. No.: US 2022/0391648 A1
(43) Pub. Date: Dec. 8, 2022

(54) CONTROL APPARATUS, PRINT CONTROLLING METHOD, AND STORAGE MEDIUM

(71) Applicant: CANON KABUSHIKI KAISHA, Tokyo (JP)

(72) Inventor: Yasuo Kurata, Kanagawa (JP)

(21) Appl. No.: 17/832,908

(22) Filed: Jun. 6, 2022

(30) Foreign Application Priority Data
Jun. 7, 2021 (JP) 2021-095039

(51) Int. Cl. G06K 15/02; G06F 3/12

(52) U.S. Cl. CPC G06K 15/1805; G06F 3/1205; G06F 3/1229

(57) ABSTRACT

Provided is a control apparatus including: a first obtaining unit configured to obtain information on a first print setting from a printer, the first print setting being settable for printing by using the printer; a second obtaining unit configured to obtain information on a second print setting in a case of printing; a determination unit configured to determine whether or not the information on the second print setting obtained by the second obtaining unit is included in the information on the first print setting obtained by the first obtaining unit; and a notification unit configured to issue notification to a user in a case where the determination unit determines that the information on the second print setting is not included in the information on the first print setting.

### BACKGROUND

### Field

The present disclosure relates to a technique for a control apparatus that transmits print data to a printing apparatus.

### Description of the Related Art

It has heretofore been a general practice to use a printer driver, which is installed on a host apparatus connected to a printer, as a measure for executing printing with the printer. There are default print settings for the printer driver. The default print settings are used as default values of the print settings in a case of performing printing by use of an application on the host apparatus.

Meanwhile, there is a device in the printer that can update contents of settable print settings. Japanese Patent Laid-Open No. 2016-224702 (hereinafter referred to as Patent Document 1) adopts a technique for causing a printer driver to obtain information on settable print settings updated by a printer by connecting the printer driver to the printer like the one mentioned above and synchronizing the printer driver with the printer. Here, the printer driver can change default print settings based on the obtained information.

### SUMMARY

Setting values set as the default print settings in the printer driver may no longer be supported in a case where the contents of the print settings are subjected to updating and the like on the printer side. In this case, the printer driver will not be able to conduct the subsequent printing based on the contents of the default print settings. Meanwhile, in the case of the printer driver configured to be synchronized with the updated contents of the print settings in the printer, the default print settings on the printer side are also changed as a result of synchronization. Here, a user may be unaware of such a change.

A control apparatus according to one aspect of the present disclosure includes: a first obtaining unit configured to obtain information on a first print setting from a printer, the first print setting being settable for printing by using the printer; a second obtaining unit configured to obtain information on a second print setting in a case of printing by using print control software; a determination unit configured to determine whether or not the information on the second print setting obtained by the second obtaining unit is included in the information on the first print setting obtained by the first obtaining unit; and a notification unit configured to issue notification to a user in a case where the determination unit determines that the information on the second print setting is not included in the information on the first print setting.

Further features of the present disclosure will become apparent from the following description of exemplary embodiments with reference to the attached drawings.

### BRIEF DESCRIPTION OF THE DRAWINGS

FIG. 1 is a diagram showing a system configuration;

FIG. 2 is a diagram showing software configurations of a host computer and a printer;

FIG. 3 is a diagram showing an example of a print setting screen provided by a user interface unit;

FIGS. 4A and 4B are tables each showing a structure of a sheet list;

FIG. 5 is a table showing a structure of sheet detail information;

FIG. 6 is a flowchart showing processing of a sheet information update program;

FIG. 7 is a diagram showing an example of a dialog notified by the user interface unit;

FIG. 8 is a flowchart showing processing in a case of execution of printing by the printer driver; and

FIG. 9 is a diagram showing an example of a dialog notified by a printer status notification unit.

### DESCRIPTION OF THE EMBODIMENTS

Preferred embodiments of the present disclosure will be described below in detail with reference to the accompanying drawings. Note that the following embodiment are not intended to limit the present disclosure as defined in the appended claims. It is to be also understood that a solution of the present disclosure does not always require a combination of all of the features described in any of the embodiments.

### First Embodiment

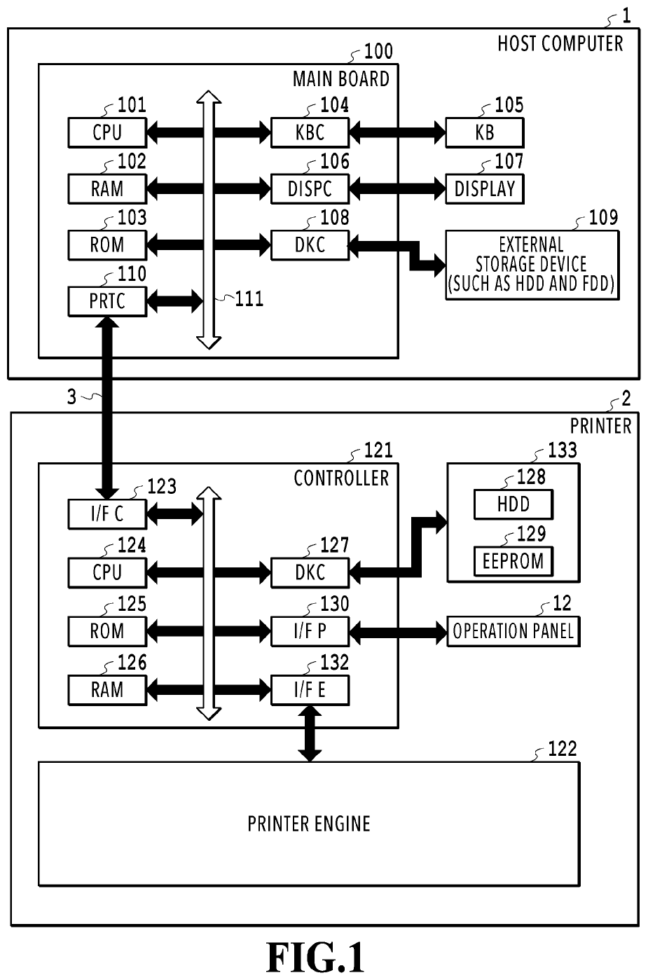

FIG. 1 is a block diagram showing an outline of a printing system which includes a host computer (hereinafter referred to as the host) 1 serving as a print control apparatus of the present embodiment, and an ink jet printer (hereinafter referred to as the printer) 2 serving as a printing apparatus. As shown in FIG. 1, the host 1 and the printer 2 are connected to each other by using a given bidirectional interface 3 (such as USB and TCP/IP). Typical examples of the host 1 include a personal computer (PC) and the like.

The host 1 includes a main board 100 provided with a CPU 101 and the like, a keyboard (KB) 105, a display unit (DISPLAY) 107 such as LCD, and an external storage device 109. The external storage device 109 includes a hard disk drive (HDD) or a flexible disk drive (FDD), for example. Meanwhile, the main board 100 includes a RAM 102, a ROM 103, a keyboard controller (KBC) 104, a display controller (DISPC) 106, a disk controller (DKC) 108, and a printer controller (PRTC) 110.

The CPU 101 generally controls the above-mentioned respective constituents connected to a system bus 111, and executes various programs. The KBC 104 controls input from the keyboard 105 or a pointing device (not shown). The keyboard controller 104 is also referred to as an operating unit or an input unit. The DISPC 106 controls display on the DISPLAY 107.

The RAM 102 functions as a main memory or a work area for the CPU 101. The ROM 103 stores an operating system, various programs in accordance with the present embodiment, a boot program, various applications, a printer control command generation program (hereinafter also referred to as a “printer driver”) serving as print control software, and the like. The DKC 108 controls access to the external storage device 109 such as the hard disk drive and the flexible disk drive. The PRTC 110 is connected to the printer 2 through the bidirectional interface 3, and controls communication processing of print data with the printer 2.

The printer 2 includes a controller 121, a printer engine 122, an operation panel 12, and a non-volatile storage device 133. The printer 2 is connected to the host 1 through the bidirectional interface 3. The non-volatile storage device 133 includes a hard disk drive (HDD) 128 or an EEPROM 129. The non-volatile storage device may also be referred to as a non-volatile memory.

The controller 121 includes a CPU 124, a ROM 125, a RAM 126, an interface controller (I/FC) 123, and a disk controller (DKC) 127. In addition, the controller 121 includes a panel interface (I/FP) 130 and an engine interface (I/FE) 132. The CPU 124 executes various programs. The ROM 125 receives the print data from the host 1, and stores programs for realizing optimum printing or various data by controlling the printer engine 122.

The RAM 126 is used as a work area for temporarily storing various data and various programs. The I/FC 123 is connected to the host 1 through the bidirectional interface 3, and controls communication processing of the print data with the host 1. The HDD 128 stores large volumes of data such as the data from the host 1 and auxiliary information concerning this data. The EEPROM 129 stores information unique to the printing apparatus used in the case of a printing operation. The DKC 127 controls access to the non-volatile storage device 133. The I/FP 130 controls display on the operation panel 12 or input from the operation panel 12. The I/FE 132 directly controls the hardware, thereby controlling the printer engine 122 that realizes the optimum printing. Although the printer engine 122 of the present embodiment uses the printer engine that applies an ink jet printing method, it is also possible to use a printer engine in accordance with an electrophotographic method or to use an offset printer.

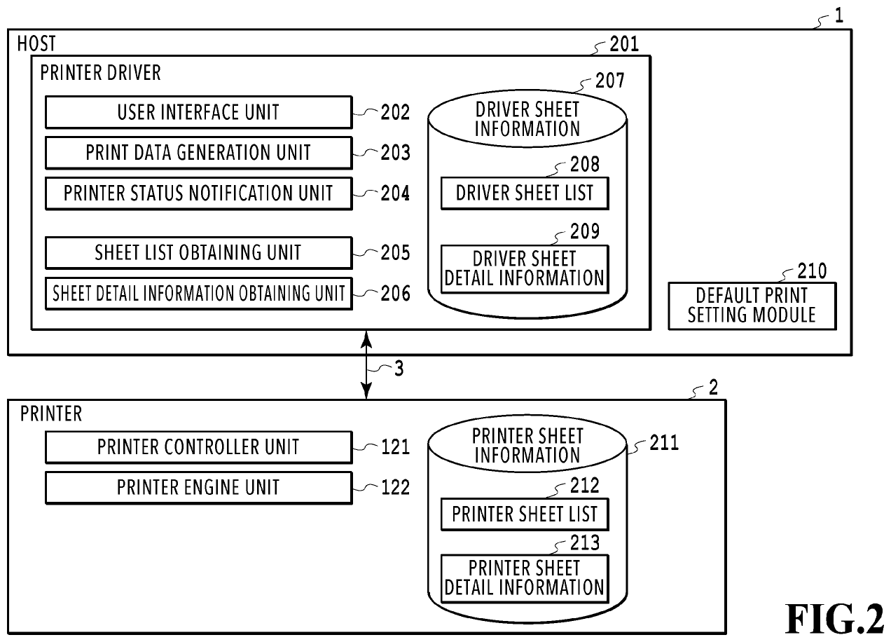

FIG. 2 is a diagram showing functional configurations of software of the host 1 and the printer 2. The printer 2 of the present embodiment is assumed to be an apparatus that can update types of printable print media (hereinafter referred to as sheet types) such as paper and textiles. In general, the printer 2 is configured to perform printing depending on the sheet types and by using processing parameters adaptable to the respective sheet types. While the printer 2 is designed to be able to perform printing on multiple sheet types at the point of shipment from a factory, the printer 2 does not support sheet types that are developed after the shipment of the printer 2. The printer 2 cannot perform printing on the unsupported sheet types. In order to enable the printer 2 to perform printing on the unsupported sheet types mentioned above, the printer 2 of the present embodiment can expand the printable sheet types. Various methods can be thought as a method of updating such a printable sheet type. One possible example of the updating method is a method of causing the printer 2 to update a function based on an instruction from a user through the operation panel 12 and the like. Other possible examples thereof include a method of updating the function based on an instruction from an external information processing apparatus and the like connected to the printer 2, a method of causing the printer 2 to update the function by receiving information through the Internet and the like. The present embodiment will be described on the assumption that the updating method is not limited to a particular method.

The host 1 includes a printer driver 201 and a default print setting module 210. The printer driver 201 serving as the print control software can be operated by the print control apparatus, and includes print settings and a unit for changing the print settings. Moreover, the printer driver 201 converts a print target document into print data interpretable by the printer 2 in accordance with contents of print settings based on a print instruction by the user, and transmits the converted print data to the printer 2. The printer 2 generates a print product by developing the received print data. The printer driver 201 includes a user interface unit 202, a print data generation unit 203, a printer status notification unit 204, a sheet list obtaining unit 205, and a sheet detail information obtaining unit 206. Moreover, the printer driver 201 includes driver sheet information 207. The driver sheet information 207 stores information concerning the sheet types that can be set as the print setting in the printer driver 201. The driver sheet information 207 includes a driver sheet list 208 and driver sheet detail information 209. The driver sheet list 208 is a list recording the types of sheets that can be set to the printer driver 201. Meanwhile, the driver sheet detail information 209 is information describing details on the respective sheet types recorded in the driver sheet list 208. The driver sheet list 208 and the driver sheet detail information 209 will be described later in detail.

The user interface unit 202 provides the user with a measure for inputting the print settings to the printer driver 201. The printer driver 201 displays a print setting screen on the DISPLAY 107 based on a command to display the print setting screen from the operating system. Information concerning the functions of the printer 2 is held in the user interface unit 202, and the printer 2 displays the print setting screen based on this information. Meanwhile, the print setting screen regarding the print setting of the sheet type is displayed based on the driver sheet information 207. Furthermore, the user interface unit 202 overwrites and updates (synchronously updates) the contents of the driver sheet information 207 by using printer sheet information 211 obtained from the printer 2.

The print data generation unit 203 generates the print data to be transmitted to the printer as a print job. The print data generation unit 203 converts a document prepared by the user into a data format interpretable by the printer 2 in accordance with the print settings set by using the user interface unit 202, and generates a control command for controlling the printer.

The printer status notification unit 204 obtains status information on a printing status, an error occurrence status, or the like of the printer 2 through the bidirectional interface 3, and displays the information on the DISPLAY 107. The sheet list obtaining unit 205 obtains a printer sheet list 212 held by the printer 2 through the bidirectional interface 3. The sheet detail information obtaining unit 206 obtains printer sheet detail information 213 held by the printer 2 through the bidirectional interface 3.

The default print setting module 210 stores default values of the print settings for performing the printing with the printer 2 while using an application on the host 1 by way of the printer driver 201. The print settings to be stored in the default print setting module 210 are obtained from the printer driver 201 by the operating system at the time of installing the printer driver 201 on the host 1, and are generated by storing the print settings in the ROM 103 on the host 1. Meanwhile, the contents of the default print setting module 210 can be changed into desired print settings by the user through the printer driver 201.

The printer 2 includes the printer controller unit 121, the printer engine unit 122, and the printer sheet information 211. The printer sheet information 211 stores information concerning the sheet types that can be set to the print setting in the printer 2, and includes the printer sheet list 212 and the printer sheet detail information 213. The printer sheet list 212 is a list that records the types of sheets supported by the printer 2. Meanwhile, the printer sheet detail information 213 is information that records details of the respective types of sheets recorded in the printer sheet list 212. The printer sheet list 212 and the printer sheet detail information 213 will be described later in detail. Although the driver sheet list 208 and the printer sheet list 212 are distinguished from each other for the convenience of description in the present embodiment, the driver sheet list 208 and the printer sheet list 212 are formed from data having the same structure, respectively. Note that the driver sheet detail information 209 and the printer sheet detail information 213 are also formed from data having the same structure, respectively.

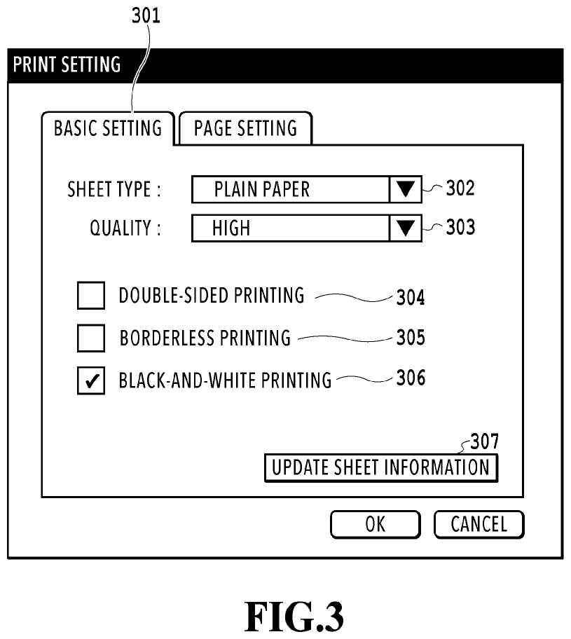

FIG. 3 shows an example of the print setting screen for the printer driver, which is provided by the user interface unit 202 in accordance with the driver sheet information 207. The print setting screen of the present embodiment includes a basic setting sheet 301, and this sheet enables setting of a sheet type 302 and several print settings concerning the sheet type 302. A quality section 303, a double-sided printing section 304, a borderless printing section 305, and a black-and-white printing section 306 are provided as functions concerning the sheet type 302.

The quality section 303 is used for selecting output quality of a print product, and has options “high”, “standard”, “fast”, and the like. The double-sided printing section 304, the borderless printing section 305, and the black-and-white printing section 306 have options “on” and “off” for the respective functions thereof, and the settings thereof are reflected to a result of printing. A sheet information update button 307 is a button for activating a sheet information update program to be described later.

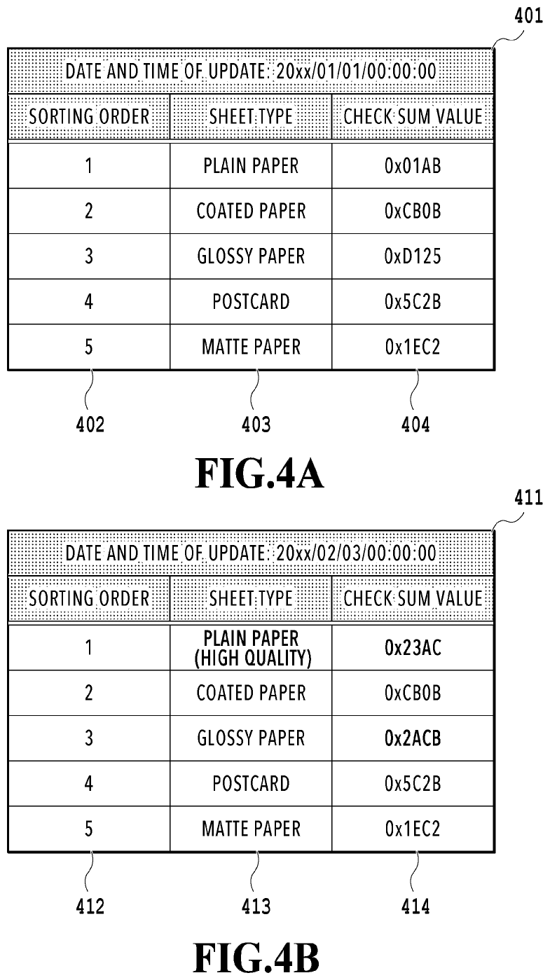

FIGS. 4A and 4B are tables showing an example of the driver sheet list 208 included in the driver sheet information 207 or the printer sheet list 212 included in the printer sheet information 211. In the present embodiment, FIG. 4A is assumed to be the driver sheet list 208 included in the driver sheet information 207 and FIG. 4B is assumed to be the printer sheet list 212 included in the printer sheet information 211. Here, the both data have the same structure. Sheet types 403 recorded in the driver sheet list 208 are provided in accordance with a sorting order 402 to the sheet type 302 shown in FIG. 3 as the options for the print setting. Moreover, the driver sheet list 208 includes date and time of update of listed information 401, and check SUM values 404 that are generated based on the driver sheet detail information 209 corresponding to the respective sheets of the sheet types 403.

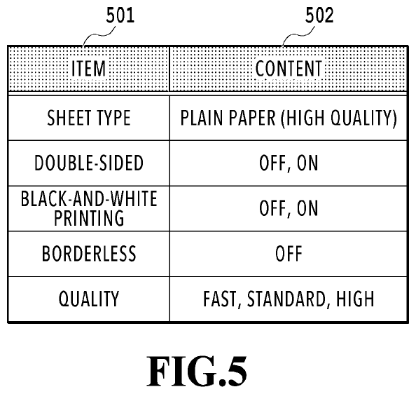

FIG. 5 shows an example of the driver sheet detail information 209 corresponding to an arbitrary one of the sheet types 403. Here, FIG. 5 shows the driver sheet detail information 209 in the case where the sheet type 403 is “plain paper (high quality)”. The driver sheet detail information 209 is formed from information tables in the same number of the sheets recorded in the sheet types 403. In the case where the arbitrary sheet type is selected from the sheet type 302 of the basic setting sheet 301, the user interface unit 202 provides the options for the quality section 303, the double-sided printing section 304, the borderless printing section 305, and the black-and-white printing section 306. These options are provided based on contents 502 of items 501 in the driver sheet detail information 209. Note that the printer sheet detail information 213 is also formed from the same structure as the information table shown in FIG. 5.

In order to perform the printing as desired by the user, it is preferable that the contents of the driver sheet list 208 included in the driver sheet information 207 coincide with the contents of the printer sheet list 212 included in the printer sheet information. For example, in the case where the print settings are updated on the printer side, it is possible to conduct the printing without any problem if the sheet type set as the default sheet type in the printer driver remains supported. On the other hand, it is not possible to conduct the printing if the sheet type set as the default sheet type in the printer driver is no longer supported as a consequence of the updating of the print settings on the printer side. What is more, since the default print settings are used as the default values in the case of printing by using the application, the user may be unaware that the set values in the default print settings are not currently supported by the printer. Given the situation, the present embodiment is configured to perform processing in accordance with the contents recorded in the driver sheet list 208 and the printer sheet list 212 in the case where the user presses the sheet information update button 307 shown in FIG. 3.

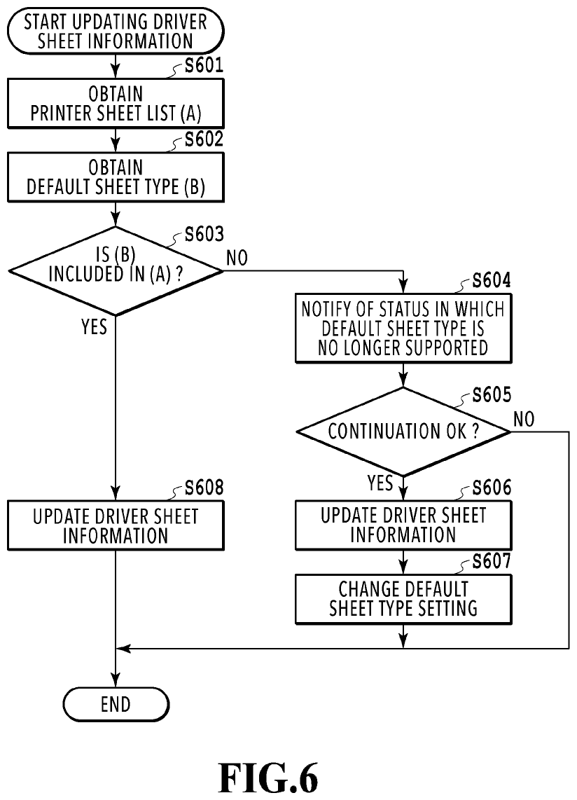

FIG. 6 is a flowchart showing a processing program of the sheet information update program. In the present embodiment, as mentioned earlier, the printer driver 201 is assumed to hold the list shown in FIG. 4A as the driver sheet list 208 and the printer 2 is assumed to hold the list shown in FIG. 4B as the printer sheet list 212. Moreover, FIG. 5 is assumed to show the printer sheet detail information 213 in the case where “plain paper (high quality)” is recorded on the printer sheet list 212. Furthermore, “plain paper” is assumed to be stored in the default print setting module 210 as the default print setting of the sheet type 302. Now, the contents of the sheet information update program to be executed by the CPU 101 in the case where the sheet information update button 307 on the user interface unit 202 is pressed under the aforementioned circumstances will be described with reference to the flowchart of FIG. 6. Note that the processing in the respective steps in FIG. 6 will be carried out by causing the CPU 101 of the host 1 to load program codes stored in the ROM 103 into the RAM 102 and to execute the program codes. Meanwhile, a sign “S” in an explanation of each processing represents a step in the flowchart.

First of all, the processing of the flowchart of FIG. 6 is started by pressing the sheet information update button 307 on the basic setting sheet 301. In S601, the CPU 101 obtains the printer sheet list 212 (hereinafter followed by a suffix A) from the printer 2 by using the sheet list obtaining unit 205. In the present embodiment, the list information having the contents shown in FIG. 4B will be obtained as the printer sheet list 212.

Next, in S602, the CPU 101 obtains the default print setting module 210 through the operating system, thus obtaining the default sheet type 302 (hereinafter followed by a suffix B) stored therein. In the present embodiment, the “plain paper” will be obtained. In S603, the CPU 101 determines whether or not the sheet type 302(B) obtained in S602 is included in the printer sheet list 212(A) obtained in S601. The processing goes to S608 in the case where the sheet type 302(B) is included therein. On the other hand, the processing goes to S604 in the case where the sheet type 302(B) is not included therein. In S604, the CPU 101 issues notification about the status in which the setting of the default sheet type 302 currently stored in the default print setting module 210 is no longer supported along with the progress in the processing of the sheet information update program.

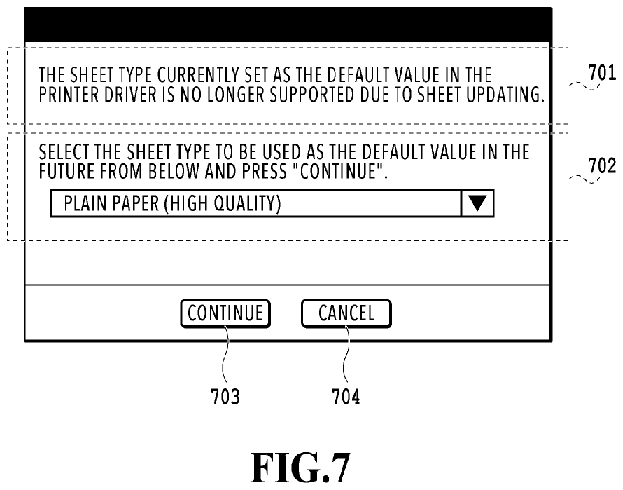

FIG. 7 shows an example of a dialog which the CPU 101 displays on the DISPLAY 1077 in S604. The dialog of FIG. 7 includes an explanation section 701 stating that the setting of the default sheet type 302 is not supported. Thus, the user is notified of the unsupported status. Moreover, the dialog includes a control section 702 used for selecting a sheet type to be used as the default sheet type 302 in the future. The control section 702 is configured to be able to select sheet types 413 included in the printer sheet list 212 obtained in S601. In addition, the dialog of FIG. 7 includes a continue button 703 and a cancel button 704. In FIG. 7, the explanation section 701 regarding the unsupported status of the setting of the default sheet type 302 and the control section 702 used for selecting the sheet type to be used as the default sheet type 302 are displayed on the same screen. Instead, these sections may be displayed one by one on different screens.

In S605, the CPU 101 determines whether or not the user presses any one of the continue button 703 and the cancel button 704 on the dialog of FIG. 7. The processing goes to S606 in the case of the determination that the user presses the continue button 703. On the other hand, the CPU 101 terminates the sheet information update program in the case where that user presses the cancel button 704 instead of the continue button 703.

In S606, the CPU 101 updates the driver sheet information 207, thereby updating the sheet types 302 that are settable in the printer driver 201. Specifically, the CPU 101 first overwrites and updates the driver sheet list 208 based on the printer sheet list 212 obtained in S601. Next, the CPU 101 obtains, by using the sheet detail information obtaining unit 206, information from the printer sheet detail information 213 on the sheet type 403 among the sheet types 403 recorded in the updated driver sheet list 208, which is not included in the current driver sheet detail information 209. Then, the CPU 101 saves the obtained printer sheet detail information 213 as the driver sheet detail information 209. In the case of the present embodiment, the driver sheet list 208 is updated from the list of FIG. 4A to the list of FIG. 4B by carrying out the processing in S606. In the meantime, the CPU 101 obtains information on the “plain paper (high quality)” among sheet types 503 recorded on the list of FIG. 4B, which is not included in the current driver sheet detail information 209, from the printer sheet detail information 213 and saves this information in the driver sheet detail information 209.

Next, in S607, the CPU 101 changes the sheet type 302 stored in the default print setting module 210. Here, the sheet type selected in the control section 702 at the timing to press the continue button 703 on the dialog of FIG. 7 in S605 is stored in the default print setting module 210. After the change, the CPU 101 terminates the sheet information update program.

In S608, the CPU 101 updates the driver sheet information 207 in order to deal with a case where the sheet types other than the sheet type set to the default sheet type on the printer sheet list are different from those on the driver sheet list. After carrying out the processing in S608, the CPU 101 terminates the sheet information update program.

As described above, according to the present embodiment, it is possible to improve usability in the case where the default print setting in the printer driver is no longer supported due to the updating of the print settings in the printer. To be more precise, in the case where the print settings registered as the default print settings are not available in the printer, the user can recognize this situation by carrying out the above-described processing flow so as to issue the notification. Here, the notification is issued in the case where the determination in S603 of FIG. 6 turns out to be yes (that is, in the case where the printer 2 cannot carry out the printing). In this way, the user is spared from unnecessary notification. Moreover, it is also beneficial to the improvement of usability for the user by allowing the user to change the default sheet type on such a notification screen at the same time.

### Second Embodiment

The present embodiment will describe a processing flow in a case of performing printing while using the printer driver 201 to set the sheet type 302 which is not supported by the printer 2,

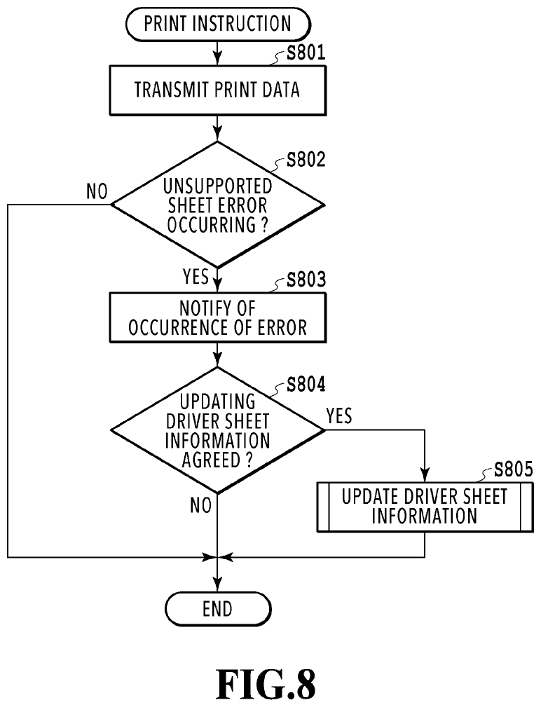

FIG. 8 is a flowchart showing processing in a case of execution of printing by the printer driver. Here, the printer driver 201 is assumed to hold the contents in FIG. 4A as the driver sheet list 208. Meanwhile, the printer 2 is assumed to hold the contents in FIG. 4B as the printer sheet list 212. Moreover, FIG. 5 is assumed to show the printer sheet detail information 213 in the case where “plain paper (high quality)” is recorded on the printer sheet list 212. Furthermore, the “plain paper” is assumed to be stored in the default print setting module 210 as the default print setting of the sheet type 302. The processing flow in the case of carrying out the printing with the printer 2 in accordance with the application on the host 1 through the printer driver 201 and in the case where the print setting of the sheet type 302 is set to the “plain paper” will be described with reference to the flowchart of FIG. 8.

The flowchart of FIG. 8 is started by issuing a print instruction from the application on the host 1 to the printer driver 201. Note that the processing in the respective steps in FIG. 8 will be carried out by causing the CPU 101 of the host 1 to load program codes stored in the ROM 103 into the RAM 102 and to execute the program codes. Meanwhile, a sign “S” in an explanation of each processing represents a step in the flowchart.

In S801, the CPU 101 generates the print data in the case of setting the “plain paper” to the sheet type 302 by using the print data generation unit 203, and transmits the generated print data to the printer 2. In S802, the CPU 101 determines whether or not the sheet type 302 set to the print data transmitted in S801 is supported by the printer 2, or in other words, whether or not a print error occurs in the printer 2. Here, the above-mentioned determination is carried out based on the status information on the printer 2 obtained by using the printer status notification unit 204. The error occurs in the case of the present embodiment because the “plain paper” is set to the sheet type 302 in the print data transmitted in S801 whereas the printer 2 does not support the “plain paper”. In this case, the processing goes to S803 as a result of the determination in S802. On the other hand, the CPU 101 terminates the program in the case where the CPU 101 determines that the error does not occur. In S803, the CPU 101 issues notification about the occurrence of the print error in the printer 2.

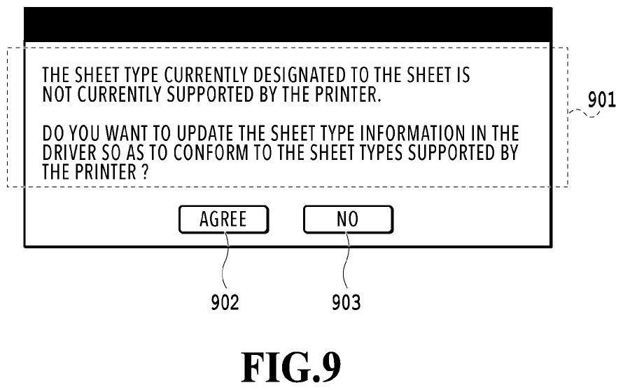

FIG. 9 shows an example of a dialog that the CPU 101 displays on the DISPLAY 107 in S803. The dialog of FIG. 9 includes an explanation section 901 stating that the setting of the sheet type 302 is not supported. Thus, the user is notified of the unsupported status. In addition, the explanation section 901 inquires of the user about whether or not to update the driver sheet information 207 in order to synchronize the printer sheet information 211 supported by the printer 2 with the driver sheet information 207. The dialog of FIG. 9 includes an agree button 902 and a no button 903 for responding to this inquiry.

In S804, the CPU 101 conducts processing branch depending on whether the user presses the agree button 902 or the no button 903 on the dialog of FIG. 9. The processing goes to S805 in the case where the user presses the agree button 902. The CPU 101 terminates the program in the case where the user presses the no button 903.

In S805, the CPU 101 performs the processing to update the driver sheet information. Specifically, the CPU 101 updates the driver sheet information 207 in the printer driver 201. In this processing, the CPU 101 starts the processing flow shown in FIG. 6. Regarding the subsequent processing, the processing flow is assumed to proceed in conformity to the contents described in the first embodiment. The CPU 101 terminates the program in the case where the processing in S805 is completed.

As described above, according to the present embodiment, it is possible to promptly notify the user of the occurrence of an anomaly by displaying the notification screen to the user in the case of performing the printing under the situation where the sheet type 302 not supported by the printer 2 is set in the printer driver 201. Moreover, it is also possible to improve usability for the user because the driver sheet information 207 can also be updated by an operation on the notification screen. Furthermore, it is also effective to issue the above-described notification even in the case where the user who updates the contents of the print settings for the printer 2 is different from the user who conducts the printing by using the printer driver 201.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-095039, filed Jun. 7, 2021, which is hereby incorporated by reference wherein in its entirety.

What is claimed is:

1. A control apparatus comprising:
a first obtaining unit configured to obtain information on a first print setting from a printer, the first print setting being settable for printing by using the printer;
a second obtaining unit configured to obtain information on a second print setting in a case of printing by using print control software;
a determination unit configured to determine whether or not the information on the second print setting obtained by the second obtaining unit is included in the information on the first print setting obtained by the first obtaining unit; and
a notification unit configured to issue notification to a user in a case where the determination unit determines that the information on the second print setting is not included in the information on the first print setting.

2. The control apparatus according to claim 1, wherein the information on the first print setting is information indicating a sheet type used for the printing.

3. The control apparatus according to claim 2, wherein the notification unit causes a display unit to notify that the sheet type is a sheet type not supported by the printer.

4. The control apparatus according to claim 2, wherein the notification unit further issues notification including an option for the sheet type used in the second print setting.

5. The control apparatus according to claim 4, wherein the option is configured to be selected from a print setting settable for the printing by using the printer, the print setting being included in the first print setting obtained by the first obtaining unit.

6. The control apparatus according to claim 2, further comprising:
a changing unit configured to change the second print setting into a sheet type selected by the user in a case where the sheet type to be used in the second print setting is selected by using the notification.

7. The control apparatus according to claim 2, further comprising:
a second notification unit configured to issue notification to the user in a case of accepting a print instruction in a state of setting a sheet type not supported by the printer.

8. The control apparatus according to claim 7, wherein the second notification unit issues the notification to user based on an error in the printer in a case where print data is transmitted to the printer.

9. The control apparatus according to claim 7, wherein the second notification unit issues notification for selecting whether or not to update sheet information settable with the print control software.

10. The control apparatus according to claim 7, wherein
the control apparatus implements the first obtaining unit, the second obtaining unit, the determination unit, and the notification unit in a case where an instruction to update sheet information is inputted to any of
notification notified by the second notification unit for selecting whether or not to update the sheet information settable with the print control software, and
a setting screen provided by the print control software.

11. The control apparatus according to claim 1, wherein the second print setting is a default print setting in a case of printing by using the print control software.

12. A non-transitory computer readable storage medium storing a program functioning as print control software operable in a control apparatus, the program causing a computer to function as:
a first obtaining unit configured to obtain information on a first print setting from a printer, the first print setting being settable for printing by using the printer;
a second obtaining unit configured to obtain information on a second print setting in a case of printing by using the print control software;
a determination unit configured to determine whether or not the information on the second print setting obtained by the second obtaining unit is included in the information on the first print setting obtained by the first obtaining unit; and
a notification unit configured to issue notification to a user in a case where the determination unit determines that the information on the second print setting is not included in the information on the first print setting.

13. A method of controlling a control apparatus comprising:
a first obtaining step of obtaining information on a first print setting from a printer, the first print setting being settable for printing by using the printer;
a second obtaining step of obtaining information on a second print setting in a case of printing by using print control software;
a determining step of determining whether or not the information on the second print setting obtained in the second obtaining step is included in the information on the first print setting obtained in the first obtaining step; and
a notifying step of issuing notification to a user in a case where the information on the second print setting is determined to be not included in the information on the first print setting in the determining step.
